(19) United States
(12) Patent Application Publication
(10) Pub. No.: US 2025/0335773 A1
(43) Pub. Date: Oct. 30, 2025

(54) LARGE LANGUAGE MODEL (LLM) PROMPT OPTIMIZATION WITH EVOLUTIONARY ALGORITHM AND GRADIENT DESCENT

(71) Applicant: Intuit Inc., Mountain View, CA (US)

(72) Inventors: Wendi CUI, Jersey City, NY (US); Jiaxin ZHANG, Mountain View, CA (US); Kamalika DAS, Saratoga, CA (US); Damien J. LOPEZ, San Diego, CA (US); Sricharan Kallur Palli KUMAR, Ann Arbor, MI (US)

(73) Assignee: Intuit Inc., Mountain View, CA (US)

(21) Appl. No.: 18/651,625

(22) Filed: Apr. 30, 2024

(51) Int. Cl. G06N 3/086; G06N 3/0895

(52) U.S. Cl. CPC G06N 3/086; G06N 3/0895

(57) ABSTRACT

A method includes performing a gradient descent mutation of a current generation of prompts by an evolutionary algorithm framework engine. The gradient descent mutation includes sending a prompt to a large language model (LLM) with an evaluation input-output pair and instructing the LLM to generate a modification recommendation for the prompt. The prompt is modified according to the modification recommendation. The modified prompt is processed by the LLM with the evaluation input output pair, causing the LLM to generate a response matching the output of the evaluation input-output pair. The modified prompt is added to a next generation of prompts.

### BACKGROUND

A prompt-based application is an application built by large language models (LLM(s)) processing a series of prompts. Prompt-based applications leverage the generative capabilities of LLMs to respond to user input utterances based on predefined prompts. Designing effective prompts for prompt-based application requires iterative prompt refinement and experimentation. Prompt engineering is desirable to design prompts that effectively communicate with LLMs to obtain optimal outcomes within the guardrails of LLM behavioral guidelines and data integrity regulations.

### SUMMARY

In general, in one aspect, one or more embodiments relate to a method. The method includes electing, by an evolutionary algorithm framework (EA) engine, a current prompt from a current generation of prompts and performing, by the EA engine, a gradient descent mutation on the current prompt to obtain a next-generation prompt. The gradient descent mutation includes sending, to a large language model (LLM), the current prompt, and an evaluation input-output (IO) pair, including an evaluation input and an evaluation output, from an evaluation dataset. The evaluation dataset includes multiple evaluation IO pairs. The gradient descent mutation further includes instructing the LLM to generate a modification recommendation to modify the current prompt. The gradient descent mutation further includes receiving, by the EA engine, the modification recommendation from the LLM and instructing the LLM to modify the current prompt based on the modification recommendation to generate the next-generation prompt. Processing the evaluation input corresponding to the evaluation IO pair based on the next-generation prompt causes the LLM to generate a response matching the evaluation output corresponding to the evaluation IO pair. The gradient descent mutation further includes adding the next-generation prompt to a next generation of prompts.

In general, in one aspect, one or more embodiments relate to a system. The system includes at least one computer processor, an evolutionary algorithm framework (EA) engine executing on the at least one computer processor and including a selection function catalog, a mutation function catalog, and a fitness function catalog, a large language model (LLM), executing on the at least one computer processor, and a data repository, stored on a physical storage device, including a training dataset, including a plurality of training input-output (IO) pairs, and an evaluation dataset, including a plurality of evaluation input-output (IO) pairs. The EA engine is configured to cause the at least one computer processor to select a current prompt from a current generation of prompts and perform a gradient descent mutation on the current prompt to obtain a next-generation prompt. The gradient descent mutation includes sending the current prompt, and an evaluation IO pair including an evaluation input and an evaluation output from the evaluation dataset, to the LLM. The gradient descent mutation further includes instructing the LLM to generate a modification recommendation to modify the current prompt, receiving the modification recommendation from the LLM, and instructing, the LLM to modify the current prompt based on the modification recommendation to obtain the next-generation prompt. Processing the evaluation input corresponding to the evaluation IO pair based on the next-generation prompt causes the LLM to generate a response matching the evaluation output corresponding to the evaluation IO pair. The gradient descent mutation further includes adding the next-generation prompt to a next generation of prompts.

In general, in one aspect, one or more embodiments relate to a method. The method includes obtaining, by an evolutionary algorithm framework (EA) engine, a training dataset including a plurality of training input-output (IO) pairs from a data repository stored on a physical storage device. A training IO pair includes a training input and a training output. The method further includes dividing the training dataset into multiple groups. A group includes multiple group training IO pairs. The method further includes obtaining an initial population of prompts corresponding to the multiple groups by processing the groups by a large language model (LLM). The method further includes obtaining an evaluation dataset including multiple evaluation input-output (IO) pairs from the data repository stored on the physical storage device. An evaluation IO pair includes an evaluation input and an evaluation output. The method further includes processing, by the LLM, multiple prompts of the initial population of prompts with evaluation inputs of the evaluation IO pairs of the evaluation dataset to obtain multiple sets of corresponding test outputs. A set of corresponding test outputs corresponds to a prompt of the multiple prompts. The method further includes determining fitness scores of the initial population of prompts based on a fitness function of the set of corresponding test outputs corresponding to the multiple prompts, and corresponding evaluation outputs of the evaluation IO pairs of the evaluation dataset. The method further includes selecting a set of prompts from the initial population of prompts wherein a fitness score of a selected prompt is higher than a prompt fitness threshold, to obtain a set of first-generation prompts.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart for gradient descent mutation of a generation of prompts in an evolutionary algorithm framework, in accordance with one or more embodiments.

FIG. 3 shows a flowchart for prompt engineering in an evolutionary algorithm framework, in accordance with one or more embodiments.

FIG. 4 shows a flowchart for determining distinct parent prompts for crossover mutation in an evolutionary algorithm framework, in accordance with one or more embodiments.

FIG. 5A shows a flowchart for calculating a hamming distance, in accordance with one or more embodiments.

FIG. 5B shows an example of calculating a hamming distance, in accordance with one or more embodiments.

FIG. 6 shows an example of generating an initial population of prompts, in accordance with one or more embodiments.

FIG. 7 shows an example of mutating a current generation of prompts to a next generation of prompts with a gradient descent mutation.

FIG. 8 shows an example of mutating two parent prompts to generate an offspring prompts with a crossover mutation.

FIG. 9A and FIG. 9B show a computing system in accordance with one or more embodiments.

Like elements in the various figures are denoted by like reference numerals for consistency.

### DETAILED DESCRIPTION

One or more embodiments are directed to the optimization of machine-generated prompts using an evolutionary algorithm framework. A prompt is an instruction to a large language model (LLM). The large language model (LLM) processes the prompt and generates an answer. Prompts are predominantly generated by humans and are prone to have inconclusive language that may cause the LLM to return sub-optimal answers. For example, the answer may be irrelevant, or mathematically or factually wrong. Moreover, prompts that are developed for one version of an LLM, for example, ChatGPT 3.0 may not be as effective or relevant when processed by a later version, for example, ChatGPT 4.0. Further, LLM behavior may be manipulated by exploiting loopholes in LLM guidelines to elicit unethical responses. Furthermore, sensitive data may be unintentionally revealed through prompts compromising data integrity and privacy. The widespread deployment of LLMs in enterprises engenders the emergent technology domain of designing effective prompts. Prompt engineering entails designing effective prompts that elicit specific responses from an LLM, considering factors like context, wording, and constraints. One aspect of prompt engineering includes generation of prompts by LLMs. LLM-generated prompts for prompt-based applications improves human effort in prompt monitoring and re-engineering. Prompt engineering may further include optimizing LLM-generated prompts. In one aspect of prompt optimization, LLM-generated prompts may be further optimized in an evolutionary algorithm framework.

Evolutionary algorithms are a class of machine learning algorithms. The principle of evolutionary algorithms is inspired by biological evolution. The algorithms mimic the process of natural selection, where individuals or candidate solutions evolve over generations. Evolutionary algorithm frameworks may be suited for machine-generated and machine-orchestrated prompt engineering.

Some terms and their definitions in the current specification are explained herein. An utterance is a written or spoken expression in natural language, mathematical notation, or other notations comprehensible by an LLM. A natural language expression is a single or multiple word(s), phrase(s), or sentence(s). An expression in mathematical notation is a single or multiple set(s), function(s), or equation(s). In the current specification, the terms “utterance” and “utterances” refer to a single written or spoken expression or a series of written or spoken expressions. The expression(s) in an utterance taken together develop context to the utterance and convey a meaning of the utterance as a whole, beyond the individual meanings of the expressions or context provided by an individual expression. A prompt is an instruction in natural language presented to an LLM. Examples of prompts include questions, requests, directions, commands, or combinations thereof. Notably, a prompt may be an instruction to generate another prompt. A parameter is an utterance presented to the LLM for processing in accordance with, or based on, a prompt. Notably, a parameter is not construed as a prompt by the LLM. One or more parameters may be presented with the prompt to the LLM. The prompt may include directions to process the parameter(s) in a specific manner. A response is an utterance generated by the LLM as a result of processing a prompt, or one or more parameters in accordance with a prompt. Notably, a response may be an LLM-generated prompt. A conversation with an LLM is a sequence of one or more prompts presented to an LLM alternating with corresponding responses generated by the LLM. In a conversation with an LLM, the prompts may be presented with one or more parameters, or alternatively, without parameters.

As a general overview, in user interactions with an LLM, the user presents a prompt to the LLM and the LLM generates a response. In some interactions, the user, or a software application through which the user is interacting with the LLM may present one or more parameters with the prompt to the LLM. The LLM processes the parameters in accordance with the prompt to generate a corresponding response. An LLM may be instructed to generate a prompt, the instructions including specific directions to generate the prompt. In some interactions, one or more parameters may be presented with a prompt including directions to generate a prompt to the LLM. The directions may include, for example, specific steps, recommendations for specific analyses, specific constraints, modifications to the presented parameters based one or more relationships between the parameters, and the like to generate the prompt. Accordingly, the LLM may process the parameters in accordance with the directions included in the prompt presented to the LLM and generate a prompt.

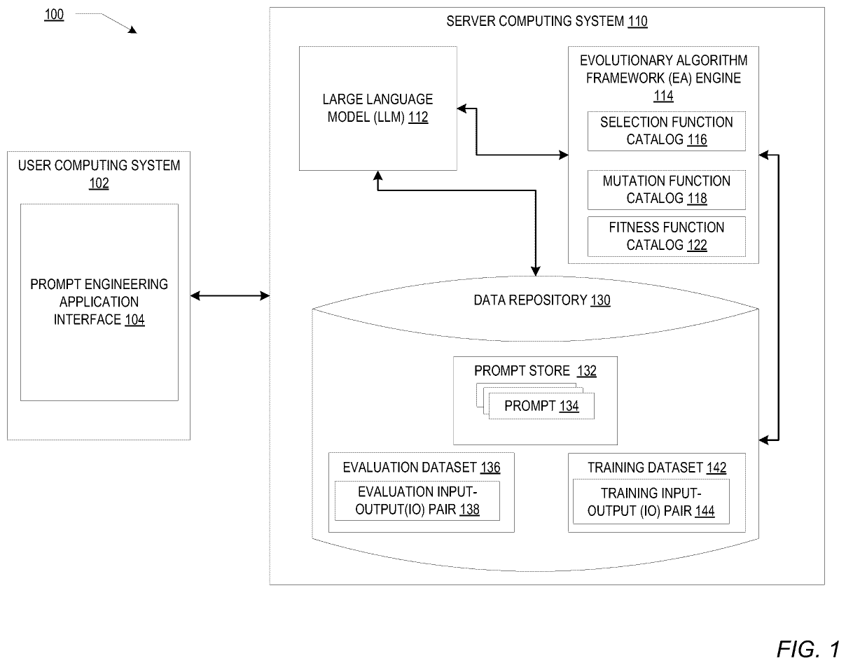

Referencing the figures, FIG. 1 shows a computing system, in accordance with one or more embodiments. The system (100) shows a server computing system (110) communicatively coupled to a user computing system (102). Each of these components are described herein.

The user computing system (102) is a computer system that is configured to execute a prompt engineering application interface (104). The prompt engineering application interface (104) includes computer program code that is configured to interact with the server computing system (110). For example, the prompt engineering application interface may be a web browser or an interface of another application. In one embodiment, the prompt engineering application interface (104) is configured to interact with the large language model (LLM) (112) via the server computing system (110). In one embodiment, the prompt engineering application interface (104) presents the user with graphical artifacts that are configured to present an interactive graphical user interface to the user for interacting with the LLM (112) via the server computing system (110). For example, the prompt engineering application interface (104) may be an AI copilot executing in a web-browser. Examples of AI copilots include the Bing copilot on Microsoft Edge®, Intuit Assist®, Shopify Sidekick®, and the like. A user may engage in a conversation with the LLM via the prompt engineering application interface.

The server computing system (110) includes a data repository (130). The data repository (130) is a type of physical storage unit or physical storage device (e.g., a file system, database, data structure, or any other storage mechanism) for storing data. The data repository (130) may include multiple different, potentially heterogeneous, storage units and/or devices. The data repository (130) is operatively and communicatively coupled to the LLM (112) and the evolutionary algorithm framework engine (EA engine) (114).

The data repository (130) includes a prompt store (132). The prompt store (132) is a logical data structure that stores multiple prompts. The prompt (134) represents a single prompt or multiple prompts and may be referred to in the singular (“prompt”) or in the plural form (“prompts”) herein. In one or more embodiments, the prompt store (132) may store prompts in various types of data structures, for example, vector stores, database records, data frames, lists, arrays, tables, and the like. In one or more embodiments, the prompts (134) may be stored as an ordered set, for batch processing by the LLM. In other embodiments, the prompts (134) may be stored in one or more groups, a group representing a generation of candidate prompts for prompt engineering and optimization by the EA engine. Prompts may be presented to an LLM via the prompt engineering application interface. Additionally, prompts may be provided programmatically to an LLM via application programming interface (API) calls, for example, OpenAI API.

The data repository (130) includes a training dataset (142) and an evaluation dataset (136). The training dataset (142) includes one or more training input-output (IO) pairs (144). The evaluation dataset (136) includes one or more evaluation input-output (IO) pairs (138). A training IO pair is an IO pair (described below) used for training the LLM to generate a specific prompt. An evaluation IO pair is an IO pair (described below) used to evaluate the effectiveness of the LLM-generated prompt.

An input-output (IO) pair is a pair of utterances, including an input utterance and an output utterance. The terms “input utterance” and “input” are interchangeably used in the current specification. In like manner, the terms “output utterance” and “output” are interchangeably used in the current specification. In one embodiment, an input utterance of an IO pair is a parameter previously presented with a prompt to an LLM. The corresponding output utterance of the IO pair is the response generated by the LLM processing the input utterance in accordance with the previously presented prompt. In one or more embodiments, the input and output of an IO pair may have at least one relationship that is comprehensible by the LLM.

In one example, the input of an IO pair may include the sentence: “Name the top three highest mountain ranges on the planet.” The corresponding output of the IO pair may include the sentence: “The Himalayas, Andes and the Rockies.”

In another example, the input utterance of an IO pair may include the sentences: “The man turned down the volume of the radio.” and “The man could not hear the woman what the woman was saying.” The corresponding output utterance of the IO pair may include the sentences: “Cause: The man could not hear the woman speak,” and “Effect: The man turned down the volume of the radio.”

In one embodiment, the input of an IO pair may include parameters previously presented with a previous prompt to the LLM, and an incorrect response generated by the LLM. The corresponding output of the IO pair may include a correct response. For example, the input utterance may include the sentences: “Parameters: The man turned the volume down; The man could not hear what the woman was saying, Incorrect response: Cause—The man turned the volume down; Effect—The man could not hear what the woman was saying.” The corresponding output utterance of the IO pair may include the sentences “Correct response: Cause—The man could not hear what the woman was saying; Effect—The man turned the volume down.” In the example, the output of the IO pair may be provided by a user via the prompt engineering application interface.

IO pairs may be created via one or more conversations or interactions with the LLM wherein the parameters and corresponding responses are stored in the data repository as IO pairs in the training dataset or in the evaluation dataset. Thus, an IO pair in the training dataset is referred to as a “training IO pair.” The input and output of a training IO pair are referred to as “training input” and “training output” respectively. Likewise, an IO pair in the evaluation dataset is referred to as an “evaluation IO pair.” The input and output of an evaluation IO pair are referred to as “evaluation input” and “evaluation output” respectively.

In continuing reference to FIG. 1, the server computing system (110) contains a large language model (LLM) (112). The LLM (112) is communicatively and operatively coupled with the data repository (130) and the evolutionary algorithm framework engine (EA engine) (114). The LLM (112) is configured to generate natural language responses to prompts, inputs, and examples. In one embodiment, the LLM (112) is a software component of the server computing system (110) as shown. In other embodiments, the LLM (112) may be a stand-alone application, part of another application, a service connected to one or more applications, or another type of software. Examples of LLMs include LaMDA, GPT-3.5, GPT-4, NeMO, Claude, and the like.

The server computing system (110) includes an evolutionary algorithm framework engine (EA engine) (114). The EA engine (114) is communicatively and operatively coupled to the LLM (112) and the data repository (130). The EA engine (114) is an application executing on the server computing system (110) that is configured to orchestrate and automate the optimization of an LLM-generated prompt in accordance with the structure and flow of an evolutionary algorithm.

Processes in an EA framework include initialization, selection, mutation, and recombination. Initialization in an EA framework entails the creation of an initial population of existing candidate solutions. Selection in an EA framework entails the selection of a current generation of candidate solutions with a higher fitness for undergoing mutation. Mutation in an EA framework entails the introduction of changes to candidate solutions of the current generation, resulting in a next generation of candidate solutions. Recombination in an EA framework entails the partial combination of two or more generations of candidate solutions. The sequence of processes is iteratively performed, continuing until the difference between the next generation and the current generation of candidate solutions is lower than a threshold. The threshold fixes a state of convergence between successive generations of candidate solutions and serves as a boundary condition to halt iteration of the sequence of processes. The threshold may be a configuration variable of the EA framework. In the context of the current specification, the candidate solution is a prompt to the LLM.

In accordance with the process sequence of an EA framework, the EA engine coordinates the iterative processing cycle of the selection of a current generation of prompts, the mutation of the prompts to create a next generation of prompts, the evaluation of the next generation of prompts based on a set of fitness scores, and the recombination of the current generation and next generation of prompts to create a new current generation. In one embodiment, the EA engine (114) is a software component of the server computing system (110) as shown. In other embodiments, the EA engine (114) may be a stand-alone application, part of another application, a service connected to one or more applications, or another type of software. Examples of evolutionary algorithm frameworks include Evolving Objects, ParadisEO, Evolutionary Computation in Java (ECJ), and the like.

The EA engine (114) further includes a selection function catalog (116), a mutation function catalog (118), and a fitness function catalog (122). As a general overview, a function catalog is an inventory of software functions, organized to optimize access, usage, and maintainability. Accordingly, the selection function catalog (116) is an inventory of selection functions. A selection function selects a set of prompts to undergo mutation. Selection functions favor prompts with higher fitness scores, while gradually eliminating prompts with lower fitness scores, determining the prompts that contribute to the next generation, and the prompts that are discarded. Examples of selection functions in the selection function catalog include Roulette Wheel selection, Boltzmann selection, Elitism selection, Stochastic Universal Sampling, and the like.

In reference now to the mutation function catalog (118), the mutation function catalog is an inventory of mutation functions. A mutation function effects optimizations to the prompts while maintaining the diversity of the prompt generation undergoing mutation. Examples of mutation functions in the mutation function catalog include gradient descent mutation, cross over mutation, group mutation, semantic mutation, and the like. In one embodiment, a mutation function may be performed by an LLM agent that processes an existing prompt presented as an input to generate a new prompt as a response. The new prompt is mutated from the prompt presented as the input. The new prompt retains some features from the input prompt includes a changed or new feature introduced by the mutation.

The fitness function catalog (122) is an inventory of fitness functions. A fitness function, in the context of the EA framework, evaluates the quality of the next generation of prompts generated in the mutation process. The fitness functions assign fitness scores to prompts based on how a prompt matches the desired criteria, for example, a fitness score threshold. The fitness functions serve to direct the EA framework toward an optimal path by favoring prompts with higher fitness scores. The fitness functions influence which prompts survive and undergo further mutation over multiple generations. Different fitness functions may focus on diverse aspects of the prompts, for example, maximizing prompt performance, minimizing prompt generation costs, and the like. Examples of fitness functions in the fitness function catalog include similarity scoring based on cosine similarities, F1 scoring, toxicity scoring, accuracy metric of a prompt, and the like. One example of toxicity scoring applies the Perspective Application Programming Interface (API) from Jigsaw® to obtain the toxicity score of the prompt. Perspective API is a machine learning-based API including functionality to recognize and mitigate semantic toxicity and promote healthy dialogue in online conversations. One example of an accuracy metric is to calculate the exact match of the output and the ground truth, by dividing the number of exact matches with the total number of candidate prompts. For example, a ground truth may be a “True/False” type answer, and the output can be evaluated against the ground truth for an exact match.

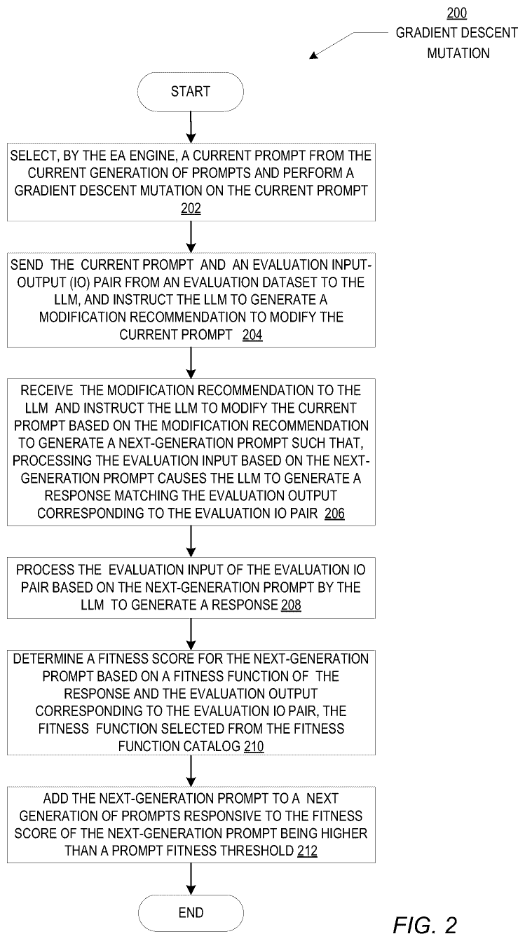

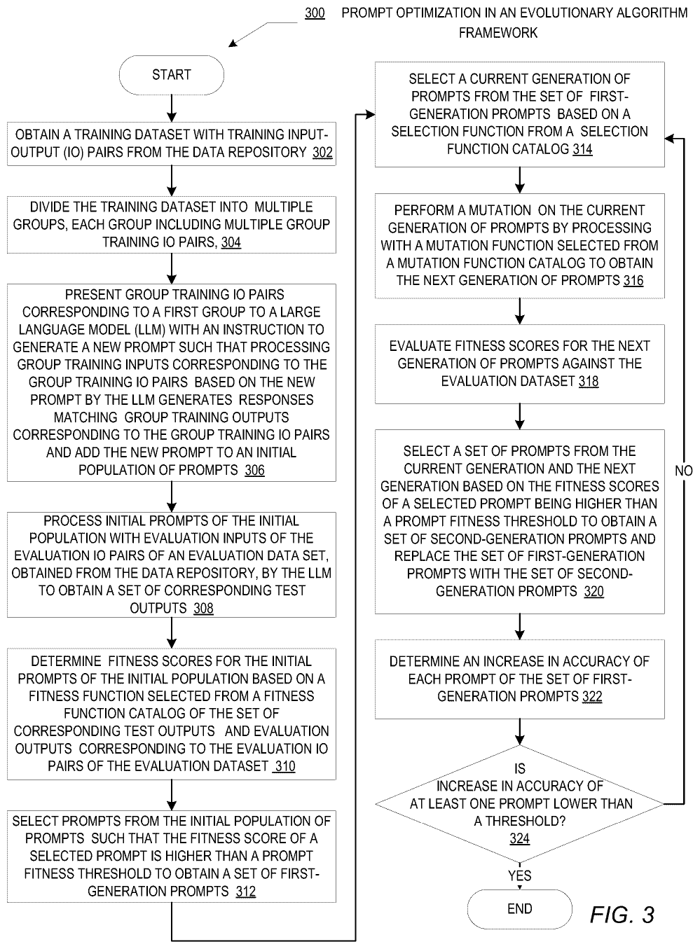

In one or more embodiments, the selection function catalog (116), mutation function catalog (118) and fitness function catalog (122), may be included as software libraries, lightweight processes, background processes, remote services, inline code, and the like. The EA engine randomly selects selection functions, and mutation functions from the correspondingly named function catalogs in an iteration of the sequence of processes i.e., selection, mutation, and recombination. Fitness functions are selected based on different criteria. A more detailed description of fitness function selection is described in reference to FIGS. 2 and 3.

While FIG. 1 shows a configuration of components, other configurations may be used without departing from the scope of one or more embodiments. For example, various components may be combined to create a single component. As another example, the functionality performed by a single component may be performed by two or more components.

FIGS. 2-5A show flowcharts in accordance with one or more embodiments. While the steps in the flowcharts are presented and described sequentially, at least some of the steps may be executed in different orders, may be combined, or omitted, and at least some of the steps may be executed in parallel. Furthermore, the steps may be performed actively or passively.

Turning now to FIG. 2, a method 200 for gradient descent mutation is presented in accordance with one or more embodiments. The method 200 is described in reference to the components of FIG. 1. In one embodiment, various blocks of the method 200 are performed by the EA engine and the LLM.

Gradient descent is an optimization algorithm commonly used in machine learning. Gradient descent aims to minimize a given function by iteratively adjusting the model parameters in the opposite direction of the gradient. In the context of the current specification, the aim of the gradient descent mutation is to cause the LLM to mutate a prompt based on a modification previously recommended by the LLM. In one embodiment, the method 200 is performed when a gradient descent mutation function is selected by the EA engine from the mutation function catalog.

At Block 202 of the method 200, a current prompt is selected from a set of current-generation prompts and a gradient descent mutation is performed. Blocks 204-212 present details of performing the gradient descent mutation. At Block 204, the current prompt, and at least one evaluation IO pair of the evaluation dataset are sent to the LLM with an instruction to generate a modification recommendation for the prompt. In some embodiments, all evaluation IO pairs are sent to the LLM with an instruction to generate a modification recommendation for the prompt. However, less than all evaluation IO pairs may be sent without departing from the scope of the claims.

When sent, the evaluation input of the evaluation IO pair corresponds to an input previously incorrectly processed by the LLM. The evaluation output of the evaluation IO pair includes the expected or correct response. In one embodiment, the instruction includes specific directions to generate a modification recommendation such that when the prompt is modified according to the generated modification recommendation, and subsequently presented to the LLM along with the evaluation input as a parameter, the LLM processes the evaluation input based on the modified prompt to generate a response that matches the evaluation output corresponding to the evaluation IO pair.

At Block 206, the modification recommendation is received by the EA engine from the LLM. Responsive to receiving the modification recommendation, the EA engine instructs the LLM to modify the current prompt according to the modification recommendation to generate a next-generation prompt such that processing the evaluation input based on the next-generation prompt causes the LLM to generate a response matching the evaluation output corresponding to the evaluation IO pair. In one embodiment, the LLM modifies the current prompt in accordance with the modification recommendation and returns the next-generation prompt.

Subsequently, the effectiveness of the next-generation prompt is assessed by evaluating the next-generation prompt. Accordingly, at Block 208, the evaluation input corresponding to the evaluation IO pair is processed by the LLM based on the next-generation prompt to generate a response. In one embodiment, the next-generation prompt, along with the evaluation input of the evaluation IO pair as a parameter, are presented to the LLM. The LLM processes the next-evaluation input in accordance with the next-generation prompt to generate a response. At Block 210, a fitness score is determined for the next-generation prompt based on a fitness function of the response generated by the LLM in Block 208 and the evaluation output corresponding to the evaluation IO pair. In one or more embodiments, the evaluation inputs corresponding to the evaluation IO pairs of the evaluation dataset are processed by the LLM with the next-generation prompt to evaluate the performance of the next-generation prompt. In one embodiment, the fitness function is selected by the EA engine from the fitness function catalog. In one embodiment, the fitness function is selected by the EA engine based on the goal of the prompt and the available data. For example, if the prompt is an instruction to check whether an input sentence is toxic, a toxicity score function is selected. In another example, if the expected response is a “True/False” type answer, an accuracy scoring function may be selected. At Block 212, the next-generation prompt is added to a next generation of prompts, responsive to the fitness score of the next-generation prompt being higher than a prompt fitness threshold. In one or more embodiments, the prompt fitness threshold may be a configuration variable of the gradient descent mutation function, a configuration variable of the EA engine, or variations thereof.

Turning to FIG. 3, the method 300 shown in FIG. 3 presents the iterative process of prompt optimization in the EA framework in accordance with one or more embodiments. The method 300 is described in reference to the components of FIG. 1. In one embodiment, various blocks of the method 300 are performed by the EA engine and the LLM. Blocks 302-310 of the method 300 present steps to obtain an initial population of prompts, in accordance with one or more embodiments.

At Block 302 of the method 300, a training dataset is obtained from the data repository stored on the physical storage device. The training dataset includes multiple training IO pairs. A training IO pair includes a training input and a training output. At Block 304, the training dataset is divided into multiple groups, a group including multiple training IO pairs. In the method 300, the training IO pairs of a group are referred to as “group training IO pairs”. In one embodiment, the total count of group training IO pairs per group is less than the total count of training IO pairs in the training dataset. In other words, the training dataset is divided into multiple groups, a group having more than one group training IO pair, and a group having less than the total number of training IO pairs in the training dataset.

At Block 306, the multiple groups are processed to obtain an initial population of prompts corresponding to the multiple groups. The initial population of prompts is generated by the LLM. In one embodiment, the multiple groups of the training dataset are processed to obtain corresponding prompts. The group training IO pairs corresponding to a first group are presented as parameters to the LLM. Additionally, an instruction to generate a new prompt is given to the LLM. The instruction further instructs the LLM that the goal of the new prompt processing the group training inputs corresponding to the group training IO pairs is to generate training responses matching group training outputs corresponding to the group training IO pairs. The LLM processes the group training IO pairs of the first group and generates the new prompt. The new prompt corresponding to the first group is added to the initial population of prompts. In one embodiment, Block 306 is iterated over the multiple groups to obtain the initial population of prompts.

At Block 308, the prompts of the initial population of prompts obtained in Block 306 undergo an evaluation with an evaluation dataset. In one or more embodiments, the evaluation dataset including multiple evaluation IO pairs may be obtained from the data repository. In one embodiment, evaluation inputs corresponding to the evaluation IO pairs of the evaluation dataset are presented to the LLM as parameters along with an initial prompt of the initial population of prompts. The evaluation inputs are processed by the LLM based on the initial prompt to generate a corresponding set of test outputs. In one embodiment, Block 308 is iterated over the initial population of prompts to obtain a corresponding set of test outputs for the prompts of the initial population of prompts. Thus, multiple prompts of the initial population of prompts are processed with evaluation inputs of the evaluation IO pairs of the evaluation dataset. Correspondingly, multiple sets of corresponding test outputs are obtained. In other words, a set of corresponding test outputs corresponds to a prompt.

At Block 310, a fitness score is determined for an initial prompt of the initial population of prompts. The fitness score is based on a fitness function of the set of test outputs corresponding to the initial prompt, and evaluation outputs corresponding to the evaluation IO pairs of the evaluation dataset. In one embodiment, the fitness function is selected by the EA engine from the fitness function catalog. In one embodiment, Block 310 is iterated over the initial population of prompts to obtain fitness scores corresponding to the prompts of the initial population of prompts.

At Block 312, prompts are selected from the initial population of prompts to obtain a set of first-generation prompts. In one embodiment, the prompts are selected based on the fitness score of a selected prompt being higher than a prompt fitness threshold to obtain the set of first-generation prompts. In one or more embodiments, the prompt fitness threshold may be a configuration variable of the EA engine that is constant for the iterations of the performance of Blocks 314-324. Alternatively, the prompt fitness threshold may be determined for an individual iteration of the performance of Blocks 314-324. In one embodiment, the handle “set of first-generation prompts” refers to the set of prompts considered as the first generation of prompts for one iteration of Blocks 314-324 of the method 300.

Blocks 314-324 present steps of the iterative sequence of processes of the EA framework of the method 300. More specifically, in one embodiment, the iterative sequence of processes of the EA framework that generate successive generations of prompts, namely, selection, mutation, recombination, and evaluation for convergence commences from Block 314. In one or more embodiments, Blocks 314-324 may be iteratively performed by the EA engine.

Accordingly, at Block 314, the set of first-generation prompts is further down selected or shortlisted based on a selection function to obtain a current generation of prompts. In one or more embodiments, the selection function may be randomly chosen by the EA engine from the selection function catalog. Randomization of the selection step based on selection functions that may be differently chosen over different iterations optimizes the diversity of the prompts in the current generation of prompts.

At Block 316, the current generation of prompts obtained in Block 314 is processed with a mutation function selected from the mutation function catalog in the EA engine. In one or more embodiments, the mutation function may be randomly chosen by the EA engine from the mutation function catalog. The current generation of prompts is processed with the mutation function to obtain a next generation of prompts.

At Block 318, fitness scores are determined for the prompts of the next generation of prompts. The determination of the fitness scores for the prompts is carried out in accordance with the steps described in Block 308 and Block 310. Namely, the next generation of prompts is evaluated against the evaluation dataset in accordance with the steps described in Block 308, to obtain corresponding sets of test outputs for prompts corresponding to the next generation of prompts. Further, the fitness score of a prompt is determined based on a fitness function of the set of test outputs corresponding to the prompt and the evaluation outputs corresponding to the evaluation IO pairs of the evaluation dataset.

Block 320 presents an embodiment of the recombination process in an EA framework. Prompts from both the current generation of prompts obtained in Block 314 and the next generation of prompts obtained in Block 316 are selected to obtain a set of second-generation prompts. In one embodiment, the prompts from the current generation and the next generation are selected to be included in the set of second-generation prompts based upon the fitness score of the prompt being higher than the fitness score threshold of Block 312. The set of first-generation prompts is then replaced with the second generation. In the context of the iterative process of Blocks 312-324, the set of second-generation prompts is now considered to be the new first generation and is referenced by the handle “set of first-generation prompts”.

At Block 322, the set of first-generation prompts obtained in Block 320 is evaluated with the evaluation dataset. An increase in accuracy of the prompts is determined. In one embodiment, the accuracy of the prompt is determined by calculating a probability of the LLM generating the right answer when processing the prompt. For example, the LLM may process twelve inputs with a prompt and return the right answer eleven times. Therefore, the probability of the prompt causing the LLM to return the right answer is calculated to be around 91.67%. At Block 324, a check is carried out to determine if the increase in accuracy of at least one prompt is lower than an increment threshold. The increment threshold represents a convergence boundary. More specifically, if the increase in accuracy is less than the increment threshold, the implication is that the current iteration has optimized the prompt to a convergence point and the iterative performance of Blocks 312-324 may end. Referring to the above example, assume that in the next iteration, the LLM processes thirteen inputs with a prompt, and returns twelve right answers. The probability of the prompt causing the LLM to return the right answer is calculated to be around 92.3%. Therefore, the increase in accuracy is determined to be an increase of 0.63%. If the increase in accuracy remains higher than the increment threshold (for example, 0.5%) the implication is that continuing the iterative process may further optimize the prompt. Accordingly, a new iteration re-commences at Block 314. On the other hand, if the increase in accuracy is lower than the increment threshold (for example, 0.7%), then, the method 300 ends.

The randomization of different mutation methods over successive iterations of Blocks 314-324 of the method 300 introduces small changes to succeeding generations of prompts and prevents the prompt population from converging prematurely to suboptimal solutions.

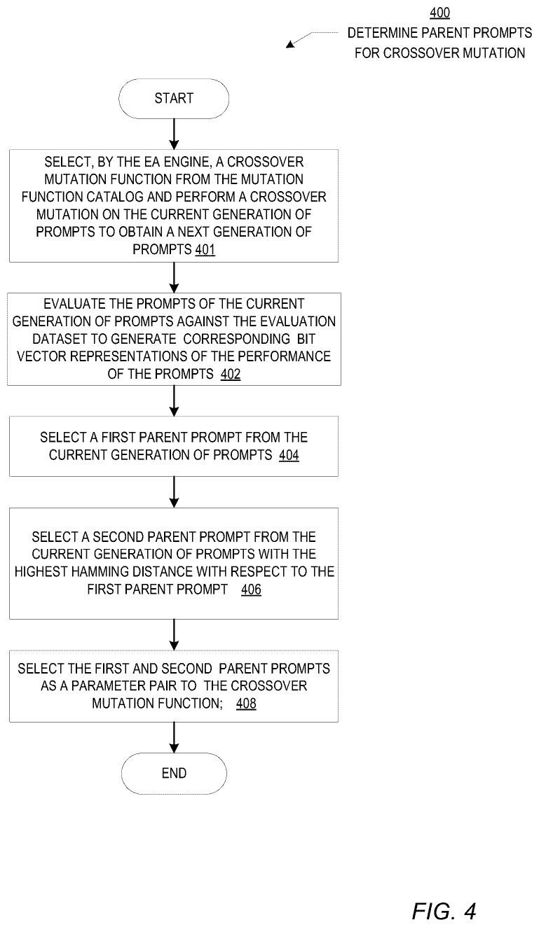

In reference now to FIG. 4, a method 400 to determine parent prompts for a crossover mutation function is presented, in accordance with one or more embodiments. The method 400 is described in reference to the components of FIG. 1. In one embodiment, various blocks of the method 400 are performed by the EA engine and the LLM.

In the context of evolutionary algorithms, a crossover is a fundamental genetic operator that generates a “genetic” diversity and explores the solution space of candidate solutions. A crossover mutation combines information from two parent candidate solutions to create an offspring solution. In the context of the current specification, the crossover mutation function combines two parent prompts to create a new prompt. Examples of crossover mutations in evolutionary algorithms include one point crossover, two-point and k-point crossovers, uniform crossovers, and the like. Crossover mutation functions generate optimal new candidate solutions when two parent candidate solutions are selected for the mutation that are as distinct as possible in the solution space. In one embodiment, the candidate solutions result in orthogonal outcomes in the solution space, for example, if a first parent candidate solution generates a first set of outcomes in the solution domain, and a second parent candidate solution generates a second set of outcomes in the solution domain, then the first set of outcomes is mutually exclusive with the second set of outcomes.

In the context of prompt optimization in an EA framework, if a first parent prompt generates a first set of responses corresponding to the evaluation IO pairs of the evaluation dataset, a second parent prompt is selected that generates a second set of responses corresponding to the evaluation IO pairs. A goal is that the first and second subsets of responses represent mutually exclusive outcomes. In other words, the first and second parent prompts do not generate the same response for the same evaluation IO pair. However, in certain cases, the two parent prompts may generate common responses, correct or incorrect, for one or more of the same evaluation IO pairs. That is, both parents may generate a common correct or a common incorrect response for the same evaluation IO pair. In these cases, a measure of distinctness or dissimilarity between the two parent prompts is obtained. The measure of distinctness is inversely proportional to the number of common responses generated by the two parent prompts.

Accordingly, the two parent prompts are selected to undergo crossover mutation based on the respective performance of the parents against the evaluation dataset. In one embodiment, bit vectors are used to represent the performance of the parent prompts against the evaluation dataset to quantify the distinctness or dissimilarity between the two parent prompts. A bit vector is a data structure that compactly stores individual bits, i.e., zeroes (“0's”) and ones (“1's”). A Hamming distance is calculated for the bit vectors of the two parent prompts. In the context of bit vectors representing prompt performance against the evaluation dataset, the Hamming distance quantifies the dissimilarity between the two bit vectors by measuring how many bits are to be changed to transform one vector into the other. Thus, the Hamming distance models the measure of distinctness of the two parent prompts. Accordingly, in one embodiment, a Hamming distance is calculated to determine which pair of parent prompts may be presented as parameters to the crossover mutation function.

At Block 401, the EA engine selects a crossover mutation function from the mutation function catalog and performs a crossover mutation on the current generation of prompts to obtain a next generation of prompts. At Block 402 of the method 400, the prompts of the current generation of prompts are evaluated against the evaluation dataset to obtain corresponding bit vector representations of the performance of the prompts. In one embodiment, the evaluation inputs corresponding to the evaluation IO pairs of the evaluation dataset are presented as parameters along with a prompt to the LLM. The LLM processes the evaluation IO pairs based on the prompt to obtain a set of corresponding test outputs. In an alternative embodiment, the test output sets generated and stored from a previous evaluation step (for example, the step of Block 322 of method 300) corresponding to the prompt, may be retrieved, for example, from the data repository. The test outputs of the set of corresponding test outputs are compared to evaluation outputs corresponding to the evaluation IO pairs to generate a bit vector corresponding to the prompt. The bit vector represents the performance of the prompt against the evaluation dataset. In one embodiment, if a test output matches the corresponding evaluation output, a ‘1’ is added to the bit vector. If the test output does not match the corresponding evaluation output, a ‘0’ is added to the bit vector. At Block 404, a first parent prompt is selected from the current generation of prompts. As described hereinabove, the Hamming distance quantifies the dissimilarity between the two vectors. That is, the greater the Hamming distance, the more distinct, or dissimilar, are the parent prompts. Therefore, the best second parent prompt is determined to be the prompt which has the greatest Hamming distance with respect to the first parent prompt.

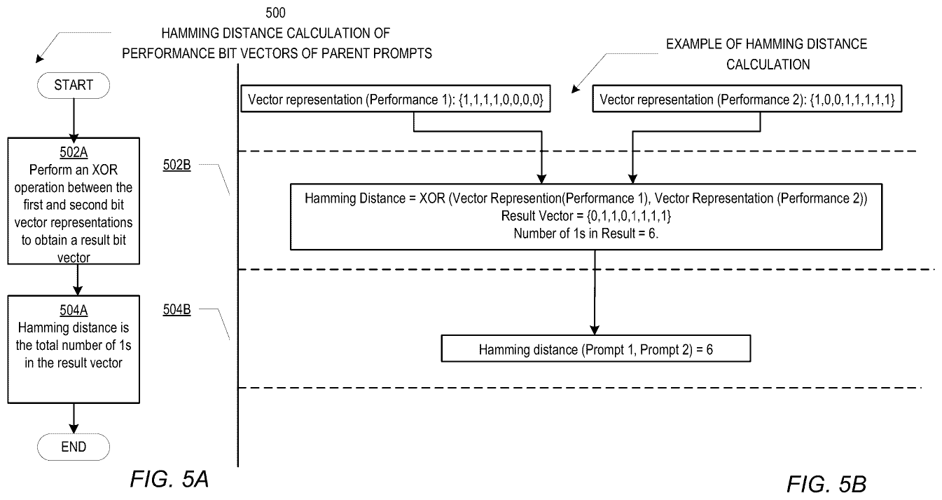

Accordingly, at Block 406, a second parent prompt with the greatest Hamming distance with respect to the first parent prompt is selected from the current generation of prompts. In one embodiment, Hamming distances between the prompts of the current generation of prompts and the first parent prompt are calculated. The prompt that has the greatest Hamming distance with respect to the first parent prompt is selected as the second parent prompt. A more detailed description of calculating the Hamming distance is provided in reference to FIG. 5. At Block 408, the first and second parent prompt are selected as a parameter pair to the crossover mutation function. In one or more embodiments, multiple parent prompt pairs are evaluated and selected from the current generation of prompts to undergo crossover mutation. The method 400 ends at Block 408.

Turning to FIG. 5A, the method 500 shown in FIG. 5A presents a method to calculate the Hamming distance between the bit vectors of a first and second prompt selected from the current generation of prompts. In one or more embodiments, the method 500 may be triggered from Block 410 of the method 400. At Block 502A of the method 500, an XOR operation is performed between the first bit vector and the second bit vector to obtain a result bit vector. At Block 504A, the number of ones (1's) in the result bit vector are counted. The count of ones (1's) in the result bit vector is the Hamming distance between the first bit vector and the second bit vector. In one embodiment, the Hamming distance is passed back as an output of the method 500 to Block 410 of the method 400.

FIG. 5B presents an example of calculating the Hamming distance between the bit vectors of the first and second prompt. Reference numeral 502B indicates a section in FIG. 5B corresponding to the step in Block 502A of the method 500, namely, performing an XOR operation between a first bit vector, {1,1,1,1,0,0,0,0} and a second bit vector {1,0,0,1,1,1,1,1}. A binary XOR operation between two bits results in 0 when the bits are identical and 1 when the bits are not identical. Accordingly, the result vector shown in the section referenced by 502B is {0,1,1,0,1,1,1,1}. Reference numeral 504B indicates the section in FIG. 5B corresponding to the step in Block 504A of the method 500. The Hamming distance is the count of Is in the result bit vector, shown to be 6.

The mutation function catalog of the EA engine further includes a semantic mutation function and a group mutation function. In one or more embodiments, the EA engine may randomly select the semantic mutation function or the group mutation function in an iteration of the sequence of processes of the EA framework. The semantic mutation function entails processing a prompt with the LLM with the instruction to return a response that is semantically equivalent to the prompt.

The group mutation function entails the creation of a set of example prompts. The population of the current generation of prompts is used as the starting set of prompts. An LLM agent is provided with the current generation of prompts with the instruction to generate a new prompt that aligns with the input set of prompts. In other words, the starting set of prompts is presented to the LLM as parameters with instructions to generate a response that shares the semantic meaning and intention with the series of input prompts.

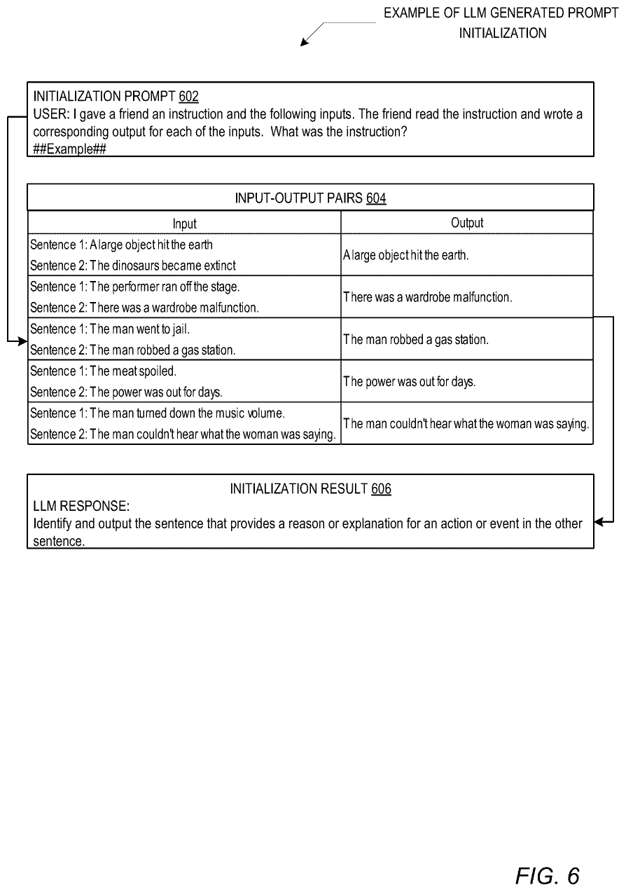

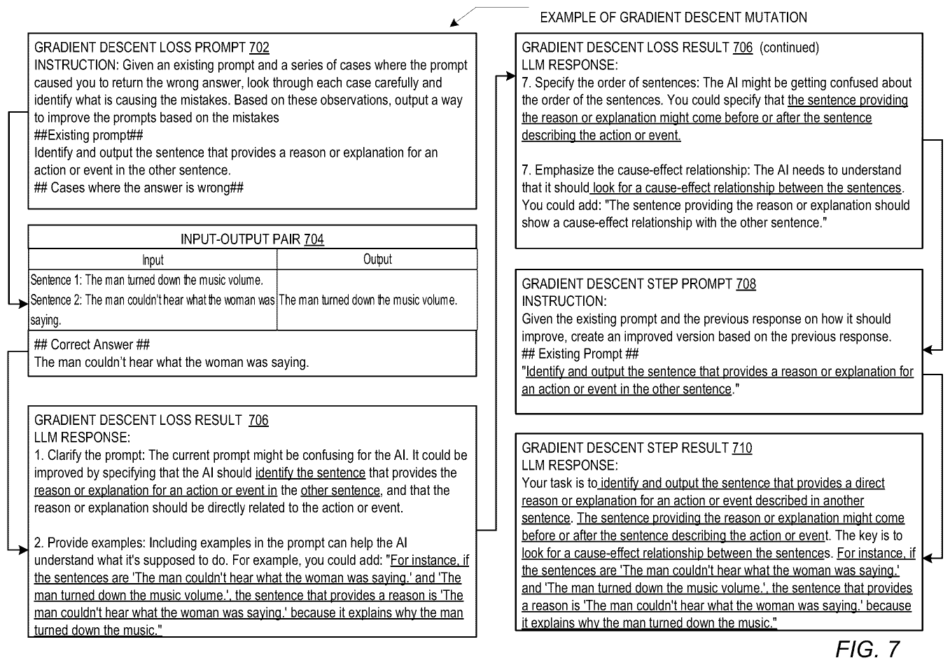

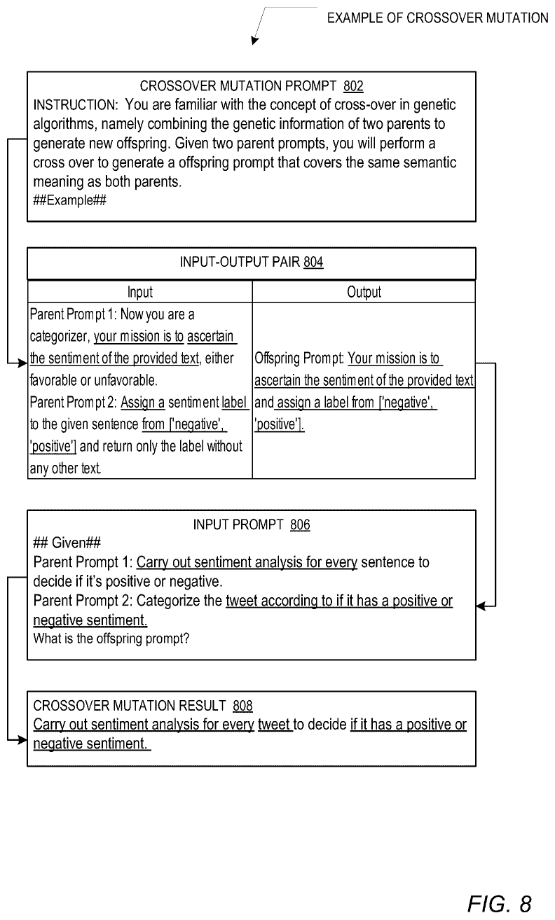

FIG. 6, FIG. 7, and FIG. 8 are examples illustrative of prompt optimization in accordance with methods 200, 300, 400, and 500. The examples of FIGS. 6, 7, and 8 are for explanatory purposes only and not intended to limit the scope of one or more embodiments.

FIG. 6 shows an example of LLM-generated prompt initialization, in accordance with one or more embodiments. Block 602 shows a user interaction with the LLM. The user provides a prompt as shown in Block 602, the instruction being in the form of a question. The question is to provide the instruction that will generate a response that matches the outputs provided with the inputs.

The user additionally presents the IO pairs shown in Block 604 as parameters to the LLM. The inputs include sentence pairs with a cause-effect relationship. To illustrate further, the first input utterance includes the sentences “A large object hit the earth,” and “The dinosaurs became extinct.” The sentences have a readily understood cause-effect relationship. The corresponding output utterance is “A large object hit the earth.” The output identifies the sentence that is the cause of the effect “The dinosaurs became extinct.” The remaining IO pairs have corresponding output utterances identifying the cause sentence of the corresponding input utterances.

The LLM processes the input-output pairs in accordance with the instruction “I gave a friend an instruction and the following inputs. The friend read the instruction and wrote a corresponding output for each of the inputs. What was the instruction?.” The LLM infers the instruction based on the examples provided by the user and generates the response shown in Block 606, namely a prompt “Identify and output the sentence that provides a reason or explanation for an action or event in the other sentence.” Thus, the LLM accurately analyses the IO pairs presented as parameters with the instruction and generates a prompt in response. The prompt generated by the LLM in Block 606 accomplishes the task of identifying the cause sentence in a sentence pair having a cause-effect relationship.

FIG. 7 shows an example of gradient based mutation, illustrating in detail the transformation of a prompt in reference to the method 200 shown in FIG. 2.

At Block 702, the LLM is provided with a wrong answer generated by the LLM in response to a prompt. The prompt is the LLM-generated prompt from the example presented in FIG. 6, Block 606. In the example, the sentences “Sentence 1: The man turned down the music volume”, and “Sentence 2: The man couldn't hear what the woman was saying”, and the LLM-generated wrong output “The man turned down the music volume” form the input utterance of the IO pair, and the correct answer “The man couldn't hear what the woman was saying” forms the output utterance of the IO pair. The IO pair is presented as a parameter to the LLM, shown in Block 704. The instruction provided to the LLM is to generate a response to improve the prompt, based on the mistake provided in the example. The LLM processes the prompt and parameter presented by the user and generates a response, shown in Block 706. The answer includes several sentences and describes modification recommendations to the prompt.

The underlined portions of the answer, “identify the sentence,” “reason or explanation for an action or event,” “For instance if the sentences are . . . ” etc., are segments of the answer generated by the LLM that the LLM re-uses to generate the mutated prompt. Upon receiving the detailed modification recommendation from the LLM, further instructions are issued to the LLM, shown in Block 708. The existing prompt is provided with an instruction to the LLM to modify the existing prompt based on the LLM-generated previous response, i.e., the modification recommendation shown in Block 706.

At Block 710, the LLM response is shown. A modified prompt is generated. The underlined sentence segments of the modified prompt shown correspond to the underlined segments of the modification recommendation generated by the LLM from Block 706. The LLM incorporates its self-generated modification recommendations into the LLM-generated prompt in the process of gradient descent mutation. Thus, the modified prompt has semantically meaningful details added, improving the effectiveness and specificity of the prompt.

FIG. 8 shows an example of crossover mutation. In Block 802, an instruction is provided to the LLM to perform a crossover to generate an offspring prompt that conveys the same semantic meaning as both parents. Additionally, an example is provided. The example is shown in Block 804. Block 804 shows an example input of two parent prompts, Parent Prompt 1 and Parent Prompt 2, and a corresponding expected output, the Offspring Prompt. The underlined segments of the Offspring Prompt correspond to the underlined segments of Parent Prompt 1 and Parent Prompt 2.

In a subsequent interaction with the LLM, shown in Block 806, two parent prompts are provided, i.e., “Carry out sentiment analysis for every sentence to decide if it's negative or positive”, and “Categorize the tweet according to if it has a positive or negative sentiment”. The parent prompts are followed by the instruction “What is the offspring prompt?”

The LLM response is shown in Block 808. The crossover mutation result is the prompt “Carry out sentiment analysis for every tweet to decide if it has a positive or negative sentiment . . . ” The underlined segments of the crossover mutation result correspond to the underlined segments of the two parent prompts shown in Block 806.

The crossover mutation function balances searching for distinct parent prompts in the current generation of prompts with fine-tuning the prompts with higher fitness scores. In the context of evolutionary algorithms, crossover mutation and group mutation allow mingling of candidate solutions from different branched pathways, creating more dynamic combinations. In the context of prompt optimization, mingling of candidate prompts from different solution spaces avoids local minima while continuing the search for the global minimum. In contrast, semantic mutation and gradient descent mutation fine-tune a prompt down a given solution pathway.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

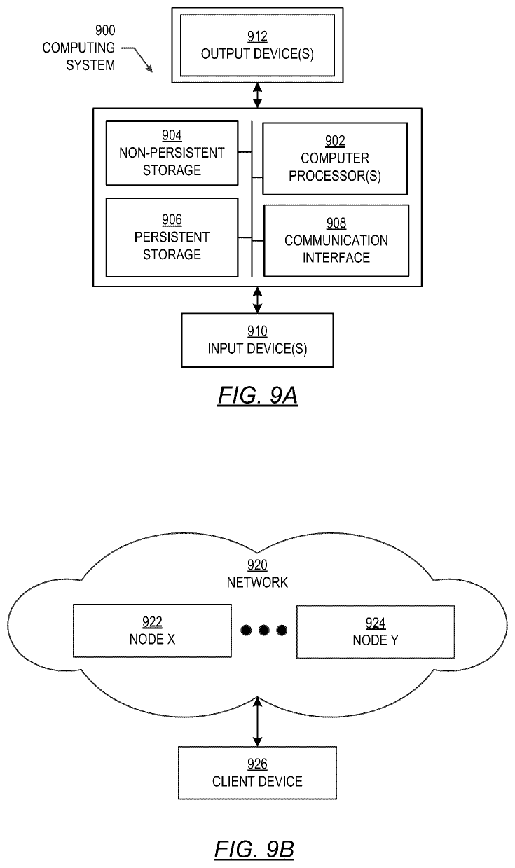

For example, as shown in FIG. 9A, the computing system (900) may include one or more computer processor(s) (902), non-persistent storage device(s) (904), persistent storage device(s) (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) (902) may be one or more cores or micro-cores of a processor. The computer processor(s) (902) includes one or more processors. The computer processor(s) (902) may include a central processing unit (CPU), a graphics processing unit (GPU), a tensor processing unit (TPU), combinations thereof, etc.

The input device(s) (910) may include a touchscreen, keyboard, mouse, microphone, touchpad, electronic pen, or any other type of input device. The input device(s) (910) may receive inputs from a user that are responsive to data and messages presented by the output device(s) (912). The inputs may include text input, audio input, video input, etc., which may be processed and transmitted by the computing system (900) in accordance with one or more embodiments. The communication interface (908) may include an integrated circuit for connecting the computing system (900) to a network (not shown) (e.g., a local area network (LAN), a wide area network (WAN) such as the Internet, mobile network, or any other type of network) or to another device, such as another computing device, and combinations thereof.

Further, the output device(s) (912) may include a display device, a printer, external storage, or any other output device. One or more of the output devices may be the same or different from the input device(s) (910). The input and output device(s) may be locally or remotely connected to the computer processor(s) (902). Many distinct types of computing systems exist, and the aforementioned input and output device(s) may take other forms. The output device(s) (912) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (902), is configured to perform one or more embodiments, which may include transmitting, receiving, presenting, and displaying data and messages described in the other figures of the disclosure.

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9A. Further, the client device (926) may include or perform all or a portion of one or more embodiments.

The computing system of FIG. 9A may include functionality to present data (including raw data, processed data, and combinations thereof) such as results of comparisons, and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
selecting, by an evolutionary algorithm framework (EA) engine, a current prompt from a current generation of prompts;
performing, by the EA engine, a gradient descent mutation on the current prompt to obtain a next-generation prompt, comprising:
sending, to a large language model (LLM), the current prompt, and an evaluation input-output (IO) pair, comprising an evaluation input and an evaluation output, from an evaluation dataset, the evaluation dataset comprising a plurality of evaluation IO pairs;
instructing the LLM to generate a modification recommendation to modify the current prompt;
receiving, by the EA engine, the modification recommendation from the LLM; and
instructing, responsive to receiving the modification recommendation, the LLM to modify the current prompt based on the modification recommendation to generate the next-generation prompt, wherein:
processing the evaluation input corresponding to the evaluation IO pair based on the next-generation prompt causes the LLM to generate a response matching the evaluation output corresponding to the evaluation IO pair; and
adding the next-generation prompt to a next generation of prompts.

2. The method of claim 1, further comprising:
processing, by the LLM, the evaluation input corresponding to the evaluation IO pair, based on the next-generation prompt, to generate the response;
determining, by the EA engine, a fitness score for the next-generation prompt based on a fitness function of the response and the evaluation output corresponding to the evaluation IO pair, wherein the fitness function is selected from a fitness function catalog; and
adding the next-generation prompt to the next generation of prompts responsive to the fitness score of the next-generation prompt being higher than a prompt fitness threshold.

3. The method of claim 1, further comprising:
obtaining, by the EA engine, a training dataset comprising a plurality of training input-output (IO) pairs from a data repository stored on a physical storage device;
dividing the training dataset into a plurality of groups, a group comprising a plurality of group training IO pairs; and
obtaining an initial population of prompts corresponding to the plurality of groups, comprising:
presenting to the LLM, group training IO pairs corresponding to a first group;
instructing the LLM to generate a new prompt, wherein
processing group training inputs corresponding to the group training IO pairs based on the new prompt by the LLM generates training responses matching group training outputs corresponding to the group training IO pairs; and
adding the new prompt corresponding to the first group to the initial population of prompts.

4. The method of claim 1, further comprising:
obtaining, by the EA engine, the evaluation dataset from a data repository stored on a physical storage device;
evaluating an initial population of prompts against the evaluation dataset, comprising:
processing, by the LLM, an initial prompt of the initial population of prompts and evaluation inputs corresponding to the evaluation IO pairs of the evaluation dataset to obtain a set of corresponding test outputs; and
determining, by the EA engine, a fitness score of the initial prompt based on a fitness function of the set of corresponding test outputs and evaluation outputs corresponding to the evaluation IO pairs of the evaluation dataset, wherein the fitness function is selected from a fitness function catalog;
selecting prompts from the initial population of prompts wherein the fitness score of a selected prompt is higher than a prompt fitness threshold, to obtain a set of first-generation prompts; and
selecting, by the EA engine, the current generation of prompts from the set of the first-generation prompts based on a selection function selected from a selection function catalog.

5. The method of claim 1, further comprising:
evaluating the next generation of prompts against the evaluation dataset;
selecting a set of prompts from the current generation of prompts and the next generation of prompts based on a fitness score of a selected prompt being higher than a prompt fitness threshold to obtain a set of second-generation prompts; and
replacing the set of first-generation prompts with the set of second-generation prompts.

6. The method of claim 1, further comprising:
evaluating the next generation of prompts against the evaluation dataset, further comprising:
processing, by the LLM, a first prompt from the next generation of prompts and evaluation inputs corresponding to the evaluation IO pairs of the evaluation dataset to obtain a set of corresponding test outputs; and
determining, by the EA engine, a fitness score of the first prompt based on a fitness function of the set of corresponding test outputs and evaluation outputs corresponding to the evaluation IO pairs of the evaluation dataset, wherein the fitness function is selected from a fitness function catalog.

7. The method of claim 1, further comprising:
selecting, by the EA engine, a crossover mutation function from a mutation function catalog;
performing a crossover mutation on the current generation of prompts to obtain the next generation of prompts, comprising:
selecting a first parent prompt and a second parent prompt from the current generation of prompts;
processing the first parent prompt and the second parent prompt with the crossover mutation function to obtain the next-generation prompt; and
adding the next-generation prompt to the next generation of prompts.

8. The method of claim 7, further comprising:
selecting the first parent prompt and second parent prompt further comprising:
evaluating the prompts corresponding to the current generation of prompts to generate corresponding bit vectors representing performances of the respective prompts against the evaluation dataset;
selecting the first parent prompt from the current generation of prompts; and
selecting the second parent prompt from the current generation of prompts wherein
the second parent prompt has a highest Hamming distance value with respect to the first parent prompt from the current generation of prompts, and wherein
the Hamming distance value is determined between a first bit vector corresponding to the first parent prompt and a second bit vector corresponding to the second parent prompt.

9. The method of claim 1, further comprising:
selecting, by the EA engine, a mutation function from a mutation function catalog, wherein the mutation function catalog comprises a gradient descent mutation function, a crossover mutation function, a semantic mutation function, and a group mutation function; and
performing the mutation on the current generation of prompts with the mutation function to obtain the next generation of prompts.

10. A system comprising:
at least one computer processor;
an evolutionary algorithm framework (EA) engine, executing on the at least one computer processor and comprising:
a selection function catalog, a mutation function catalog, and a fitness function catalog;
a large language model (LLM), executing on the at least one computer processor; and
a data repository, stored on a physical storage device, comprising:
a training dataset, comprising a plurality of training input-output (IO) pairs, and an evaluation dataset, comprising a plurality of evaluation input-output (IO) pairs;
wherein:
the EA engine is configured to cause the at least one computer processor to:
select a current prompt from a current generation of prompts;
perform a gradient descent mutation on the current prompt to obtain a next-generation prompt, comprising:
sending the current prompt, and an evaluation IO pair comprising an evaluation input and an evaluation output from the evaluation dataset, to the LLM;
instructing the LLM to generate a modification recommendation to modify the current prompt;
receiving the modification recommendation from the LLM;
and instructing, responsive to receiving the modification recommendation, the LLM to modify the current prompt based on the modification recommendation to obtain the next-generation prompt, wherein processing the evaluation input corresponding to the evaluation IO pair based on the next-generation prompt causes the LLM to generate a response matching the evaluation output corresponding to the evaluation IO pair; and
add the next-generation prompt to a next generation of prompts.

11. The system of claim 10, wherein:
the EA engine is further configured to cause the at least one computer processor to:
cause the LLM executing on the at least one computer processor to process the next-generation prompt and the evaluation input of the evaluation IO pair to generate the response;
determine a fitness score for the next-generation prompt based on a fitness function of the response and the evaluation output corresponding to the evaluation IO pair, wherein the fitness function is selected from the fitness function catalog; and
add the next-generation prompt to the next generation of prompts responsive to the fitness score of the next-generation prompt being higher than a prompt fitness threshold.

12. The system of claim 10, wherein:
the EA engine is further configured to cause the at least one computer processor to:
obtain the training dataset from the data repository stored on the physical storage device;
divide the training dataset into a plurality of groups, a group comprising a plurality of group training IO pairs; and
obtain an initial population of prompts corresponding to the plurality of groups, comprising:
presenting to the LLM, group training IO pairs corresponding to a first group;
instructing the LLM to generate a new prompt, wherein
processing group training inputs corresponding to the group training IO pairs based on the new prompt by the LLM generates training responses matching group training outputs corresponding to the group training IO pairs; and
adding the new prompt corresponding to the first group to the initial population of prompts.

13. The system of claim 10, wherein:
the EA engine is further configured to cause the at least one computer processor to:
obtain the evaluation dataset from the data repository stored on the physical storage device;
evaluate an initial population of prompts against the evaluation dataset, comprising:
processing, by the LLM, an initial prompt of the initial population of prompts and evaluation inputs corresponding to the evaluation IO pairs of the evaluation dataset to obtain a set of corresponding test outputs; and
determining a fitness score of the initial prompt based on a fitness function of the set of corresponding test outputs and evaluation outputs corresponding to the evaluation IO pairs of the evaluation dataset, wherein the fitness function is selected from the fitness function catalog;
select prompts from the initial population of prompts wherein the fitness score of a selected prompt is higher than a prompt fitness threshold, to obtain a set of first-generation prompts; and
select the current generation of prompts from the set of the first-generation prompts based on a selection function selected from the selection function catalog.

14. The system of claim 10, wherein:
the EA engine is further configured to cause the at least one computer processor to:
evaluate the next generation of prompts against the evaluation dataset;
select a set of prompts from the current generation of prompts and the next generation of prompts based on a fitness score of a selected prompt being higher than a prompt fitness threshold to obtain a set of second-generation prompts; and
replace the set of first-generation prompts with the set of second-generation prompts.

15. The system of claim 10, wherein:
the EA engine is further configured to cause the at least one computer processor to:
evaluate the next generation of prompts against the evaluation dataset, further comprising:
processing, by the LLM, a first prompt from the next generation of prompts and evaluation inputs corresponding to the evaluation IO pairs of the evaluation dataset to obtain a set of corresponding test outputs; and
determining, by the EA engine, a fitness score of the first prompt based on a fitness function of the set of corresponding test outputs and evaluation outputs corresponding to the evaluation IO pairs of the evaluation dataset, wherein the fitness function is obtained from the fitness function catalog.

16. The system of claim 10, wherein:
the EA engine is further configured to cause the at least one computer processor to:
select a crossover mutation function from the mutation function catalog;
perform a crossover mutation on the current generation of prompts to obtain the next generation of prompts, comprising:
selecting a first parent prompt and a second parent prompt from the current generation of prompts;
processing the first parent prompt and the second parent prompt with the crossover mutation function to obtain the next-generation prompt; and
add the next-generation prompt to the next generation of prompts.

17. The system of claim 16, wherein:
the EA engine is further configured to cause the at least one computer processor to:
select the first parent prompt and the second parent prompt from the current generation of prompts, wherein selecting further comprises;
evaluating the prompts corresponding to the current generation of prompts to generate corresponding bit vectors representing performances of the respective prompts against the evaluation dataset;
selecting the first parent prompt from the current generation of prompts; and
selecting the second parent prompt from the current generation of prompts wherein
the second parent prompt has a highest Hamming distance value with respect to the first parent prompt from the current generation of prompts, and wherein
the Hamming distance value is determined between a first bit vector corresponding to the first parent prompt and a second bit vector corresponding to the second parent prompt.

18. A method comprising:
obtaining, by an evolutionary algorithm framework (EA) engine, a training dataset comprising a plurality of training input-output (IO) pairs from a data repository stored on a physical storage device, a training IO pair comprising a training input and a training output;
dividing, by the EA engine, the training dataset into a plurality of groups, a group comprising a plurality of group training IO pairs;
obtaining, by the EA engine, an initial population of prompts corresponding to the plurality of groups by processing the plurality of groups by a large language model (LLM);
obtaining, by the EA engine, an evaluation dataset comprising a plurality of evaluation input-output (IO) pairs from the data repository stored on the physical storage device, an evaluation IO pair comprising an evaluation input and an evaluation output;
processing, by the LLM, a plurality of prompts of the initial population of prompts with evaluation inputs of the evaluation IO pairs of the evaluation dataset to obtain a plurality of sets of corresponding test outputs, wherein a set of corresponding test outputs corresponds to a prompt of the plurality of prompts;
determining, by the EA engine, fitness scores of the plurality of prompts of the initial population of prompts based on a fitness function of the set of corresponding test outputs corresponding to the prompt of the plurality of prompts, and corresponding evaluation outputs of the evaluation IO pairs of the evaluation dataset; and
selecting, by the EA engine, a set of prompts from the initial population of prompts wherein a fitness score of a selected prompt is higher than a prompt fitness threshold, to obtain a set of first-generation prompts.

19. The method of claim 18, further comprising:
performing, by the EA engine, at least one iteration of:
selecting a current generation of prompts from the set of first-generation prompts, based on a selection function selected from a selection function catalog;
selecting a mutation function from a mutation function catalog;
performing a mutation on the current generation of prompts by processing the current generation of prompts with the mutation function to obtain a next generation of prompts;
evaluating the fitness scores of the next generation of prompts against the evaluation dataset;
selecting a set of prompts, from the current generation of prompts and the next generation of prompts, based on a fitness score of the selected prompt being higher than the prompt fitness threshold to obtain a set of second-generation prompts; and
replacing the set of first-generation prompts with the set of second-generation prompts.

20. The method of claim 19, further comprising:
determining, by the EA engine, an increase in accuracy of the set of first-generation prompts; and
ending the at least one iteration, responsive to the increase in the accuracy of at least one prompt of the set of first-generation prompts being lower than a threshold.
